(19) United States
(12) Patent Application Publication
(10) Pub. No.: US 2015/0007064 A1
(43) Pub. Date: Jan. 1, 2015

(54) AUTOMATIC GENERATION OF A WEBPAGE LAYOUT WITH HIGH EMPIRICAL PERFORMANCE

(71) Applicant: KOBO Incorporated, Toronto (CA)

(72) Inventor: Inmar-Ella GIVONI, Toronto (CA)

(21) Appl. No.: 13/929,675

(22) Filed: Jun. 27, 2013

(51) Int. Cl. G06F 3/0481

(52) U.S. Cl. CPC G06F 3/0481
USPC 715/760

(57) ABSTRACT

Systems and methods for automatic generation and efficient exploration of a large number of webpage layouts to discover a layout with superior empirical performance. A set of variants can be automatically generated based on a baseline webpage layout by incremental modification. The set of variants are displayed to visitors in accordance with a display probability distribution. Data related to visitors' interactions to the variants are collected and processed to evaluate their respective performances. The display probability distribution may be dynamically adjusted based on the evaluation. Poorly performing variants can be discarded and promising variants may be added for exploration. Eventually, a layout variant with superior performance can be automatically determined.

### TECHNICAL FIELD

The present disclosure relates generally to the field of webpage generation, and, more specifically, to the field of automatic generation of webpages related to e-commerce.

### BACKGROUND

It is well recognized that different placements of a piece of information on a webpage may attract different levels of attention from an average visitor, or viewer. For example, in the context of e-commerce marketing, a product advertisement may be more likely to be viewed or clicked if the advertisement is placed at the top center, rather than at a corner of the webpage, etc. Visitors' attention to an advertised product is renownedly correlated to their propensity to enter into a business transaction for the product. In accordance with the correlation, the marketing performance of a webpage layout can be evaluated by the statistics of visitor interactions with the webpage. For example, the number of purchases made after viewing a webpage divided by the number of views, or the conversion rate, can be a fairly effective indication of the users' interest in the advertised products and therefore their tendency of purchasing the products.

A webpage may typically include several on-screen applications, or widgets. Given a number of available widgets, numerous webpage layouts can be yielded through various selections and placements of the widgets. Conventionally, a webpage layout is generated manually and typically relies on no more than a few web designers' subjective judgment and personal taste. Since manually creating and amending webpage layouts involve laborious and time consuming processes, an attempt to explore a large number of layouts to obtain an effective layout by such manual means is likely unrealistic.

### SUMMARY OF THE INVENTION

Therefore, it would be advantageous to provide a mechanism for automatic generation and efficient empirical exploration of a large number of webpage layouts that will discover one or more optimal layouts with high marketing performance. Accordingly, embodiments of the present disclosure employ a computer implemented method of automatically generating a set of layout variants from a pre-existing webpage layout based on predefined criteria, and exploring the set of variants by virtue of dynamically adjusting display probability distribution in accordance with the respective marketing performance of the variants. Effectively, the e-commerce effectiveness of the variants can be used to grade each variant. The grade of the variant may control the probability of subsequent presentation of the variant to a website visitor.

The pre-existing webpage layout may be an expert created layout and may include a number of widgets arranged in a pattern. A number of permitted modification rules regarding the placement and selection of widgets may be predefined to guide the generation and adjustment of the set of variants. The set of variants are displayed to visitors based on a display probability distribution. Data related to visitors' interactions to the variants are collected and processed to evaluate or score or grade their respective marketing performance. The display probability distribution may be dynamically adjusted based on the evaluation. Poorly performing variants can be discarded and promising variants may be added for exploration. As a result, an optimal or effective layout variant can be automatically determined in this fashion.

In one embodiment of the present disclosure, a computer implemented method of automatically determining a webpage layout for a website comprises: (1) accessing a first webpage layout that comprises a first plurality of widgets arranged in respective page locations; (2) generating a set of variants based on the first webpage layout in accordance with predefined constraints, wherein each variant is a webpage layout comprising a respective plurality of widgets having respective page locations; (3) displaying the set of variants to visitors so that each user views a different variant to the website in accordance with a display probability distribution, wherein each variant is assigned with a respective display probability value; (4) evaluating the set of variants based on statistics collected from respective visitor responses; (5) adjusting the set of variants and the display probability distribution based on the evaluating; (6) repeating the evaluating; and (7) selecting a resultant webpage layout from the set of variants based on the evaluations. The set of variants may be dynamically generated by incrementally modifying the first webpage layout based on the predefined constraints using a random local process. The evaluation process may comprise scoring a performance indicator associated with each of the set of variants, such as conversion rate, revenue, profit, clicks, engagement, and a combination thereof. The display probability distribution may be dynamically updated in accordance with a Bayesian strategy based on the scoring the performance indicator. The set of variants may be adjusted by adding a new variant that is dynamically generated, and removing a variant from the set of variants if a display probability value associated therewith falls below a predetermined threshold. A new variant can be selected from one of: incremental modification of an existing variant with a superior evaluation score; an incremental modification of the first webpage layout; and an expert-generated variant that is substantially different from the first webpage layout.

In another embodiment of present disclosure, a non-transitory computer-readable storage medium embodying instructions that, when executed by a processing device, cause the processing device to perform a method of automatically selecting a webpage layout for a website, wherein the method comprises: (1) accessing a set of webpage layouts, wherein the set of webpage layouts are generated based on an initial webpage layout in accordance with predefined constraints; (2) presenting the set of webpage layouts to visitors to the website in accordance with a probability distribution that comprises a respective probability value assigned for each webpage layout of the set of webpage layouts; (3) evaluating the set of webpage layouts based on visitors' interactions with the set of webpage layouts; (4) dynamically adjusting the probability distribution based on the evaluating; (5) dynamically modifying the set of webpage layouts based on the evaluating and the adjusting; (6) repeating the evaluating; and (7) selecting a resultant webpage layout from the set of webpage layouts based on the evaluating.

In another embodiment of present disclosure, A system comprising: a processor; a network circuit; and a memory coupled to the processor and comprising instructions that, when executed by the processor, cause the processor to perform an automated method of selecting a webpage layout for a website, the method comprising: (1) accessing a first webpage layout that comprises a first plurality of widgets arranged in respective page locations; (2) automatically generating a set of variants based on the first webpage layout in accordance with predefined constraints, each variant corresponding to a webpage layout comprising a respective plurality of widgets arranged in a plurality of page locations; (3) displaying the set of variants to visitors of the website in accordance with a display probability distribution, each variant assigned with a respective display probability value; (4) evaluating the set of variants based on statistic data collected from respective visitor responses; (5) adjusting the set of variants based on the evaluating; (6) adjusting the display probability distribution based on the evaluating; (7) repeating the evaluating; and (8) selecting a resultant webpage layout from the set of variants based on the evaluating.

This summary contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 illustrates an exemplary webpage layout including a plurality of widgets placed in respective page locations in accordance with an embodiment of the present disclosure.

FIG. 2A illustrates an exemplary webpage layout that can be used as a baseline layout to spawn a set of variants for empirical exploration in accordance with an embodiment of the present disclosure.

FIG. 2B illustrates an exemplary layout variant that can be automatically generated by swapping locations of two widgets in FIG. 2A in accordance with an embodiment of the present disclosure.

FIG. 2C illustrates an exemplary layout variant that is automatically generated by substituting a widget in FIG. 2A in accordance with an embodiment of the present disclosure.

FIG. 3 is a flow chart illustrates an exemplary computer implemented method of determining a resultant webpage layout by using dynamically—adjusting parallel tests to explore a set of layout variants based on user interactions related thereto in accordance with an embodiment of the present disclosure.

FIG. 4 is a flow chart illustrating an exemplary computer implemented method of dynamically adjusting the compositions of the set of variants during the empirical exploration in accordance with an embodiment of the present disclosure.

FIG. 5 is a block diagram illustrating an exemplary structure of an automatic webpage layout generation system in accordance with an embodiment of the present disclosure.

FIG. 6 is a block diagram illustrating an exemplary computing system including an automatic webpage layout generator in accordance with an embodiment of the present disclosure.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### Notation and Nomenclature

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

### Automatic Generation of a Webpage Layout with High Empirical Performance

Overall, embodiments of the present disclosure employ an A/B type testing scheme and an automatic loop process of showing a selection of layout variants in a probability distribution, assessing the relative performances of the set of variants, and dynamically adjusting the set of variants and respective display distribution probabilities by using the assessment results as the feedback. More explicitly, a set of variants are generated and presented to visitors in respective proportions or distribution probabilities. The respective impacts of the variants on visitors are assessed and compared based on statistic data collected from visitor interactions with the variants. The assessment results are then incorporated to modify the set of variants, such as removing a badly performing one and adding a promising one, and to adjust the distribution probabilities for instance. The modified set of variants are then displayed in the respective adjusted distribution probabilities, and assessed again. Eventually one or more variants with superior performances can be advantageously determined empirically and automatically.

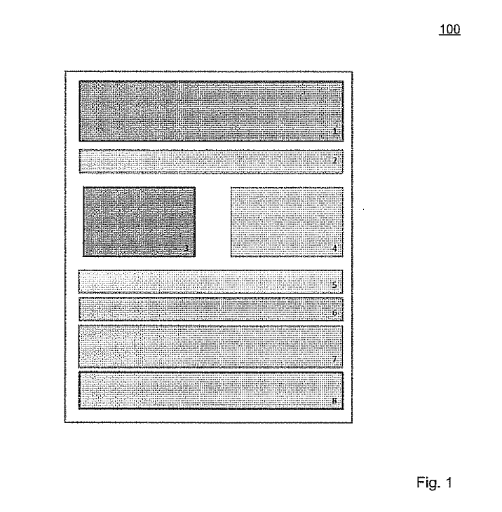

FIG. 1 illustrates an exemplary webpage layout 100 including a plurality of widgets placed in respective page locations in accordance with an embodiment of the present disclosure. The exemplary webpage layout 100 is partitioned into 8 slots for instance that can be populated from a pool of widgets. For example, for an on-line book store, the pool of widgets may include a search bar, several lists of merchandise items, several recommendation lists, several marketing images, a top 50 merchandise list, top 50 lists in category of merchandise, e.g. fiction, romance, and business, and etc. For instance, the several lists of merchandise items may include lists of hot and new, popular pick, and new releases, NY Times list, Globe and Mail list, and so on. The webpage layout 100 may be generated by expert-created or automatically generated in accordance with an embodiment of the present disclosure. Almost any widget type or subject matter presentation can be used.

In one embodiment, a layout variant refers to a particular choice of which widgets to be placed in which slots. Given a webpage template having S slots and W eligible widgets, there may be up to

$$\frac{W !}{( W - S ) !}$$

possible variants. For instance, if S=8 and W=12, there are almost 20 million possible variants in total. Exhaustive testing can be a feasible option for smaller S and W in some embodiments, but may not be efficient for large S and W scenarios. Thus, in some other embodiments, a set of predefined constraints and/or allowable variations can be imposed to confine the search to only some reasonably promising variants. For example, a constraint can specify that every variant should include the search bar and the recommendation widgets, and that the marketing image widget should not be placed at the top slot.

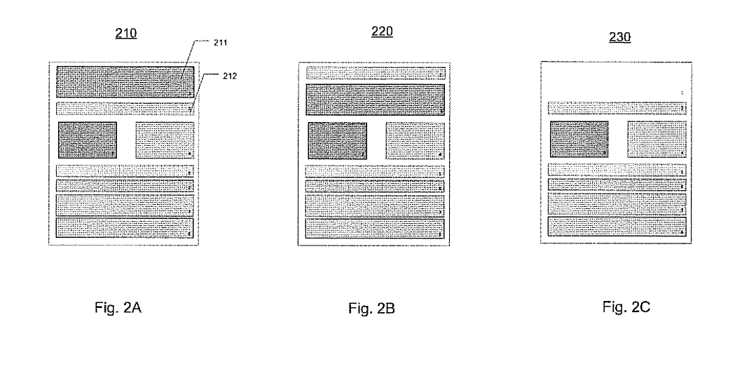

Starting with an initial webpage layout created by an expert, e.g., webpage designer, it can be reasonably presumed that an optimal variant outcome form the empirical search process may not be substantially different from the initial layout. In some embodiments, the set of variants used for a search process can be generated by incrementally modifying the initial webpage layout. Such modifications may include swapping locations of any two widgets and substituting a currently used widget with a currently unused widget, as shown in FIG. 2A-FIG. 2C for example.

FIG. 2A illustrates an exemplary webpage layout 210 that can be used as a baseline layout to spawn a set of variants for empirical exploration in accordance with an embodiment of the present disclosure. Similar with FIG. 1, the exemplary layout 210 encompasses S=8 rectangular slots that are populated with widgets 1-8, e.g. selected from W=12 widgets. FIG. 2B illustrates an exemplary layout variant 220 that can be automatically generated by swapping locations of two widgets 211 and 212 in FIG. 2A in accordance with an embodiment of the present disclosure. By swapping locations of any two widgets in FIG. 2A, 28

$$( = \frac{S ( S - 1 )}{2} )$$

variants can be derived. FIG. 2C illustrates an exemplary layout variant 230 that is automatically generated by substituting a widget 211 in FIG. 2A in accordance with an embodiment of the present disclosure. By substituting a widget currently used in the initial layout 210 with a currently unused widget, 32 (=S×(W−S)) variants can be automatically derived. Then the 60 variants can be published on the website for empirical exploration. As demonstrated by the example, starting with a set of variants derived by incrementally automatically modifying of the initial webpage layout, as well as imposing constraints and prescribed rules in searching for new variants to add for exploration, significantly reduces the number of variants for exploration and effectively confine the search scope to the most promising layout design, advantageously expedites converging of the search result.

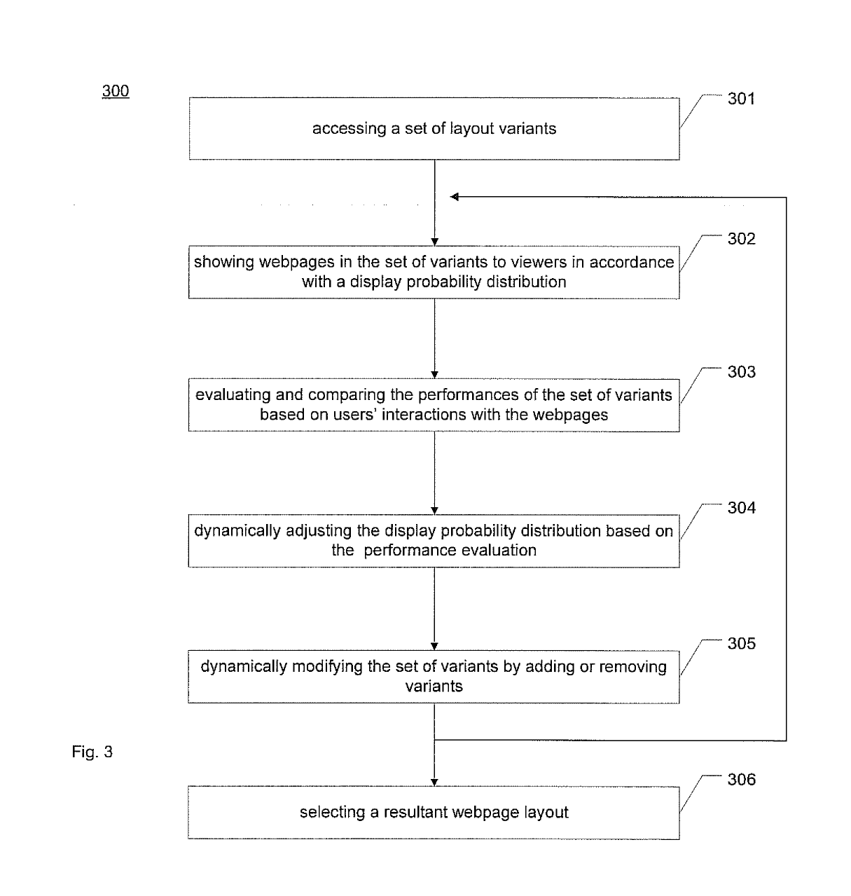

FIG. 3 is a flow chart illustrates an exemplary computer implemented method 300 of determining a resultant webpage layout by using dynamically-adjusting parallel tests to explore a set of layout variants based on user interactions related thereto in accordance with an embodiment of the present disclosure. At 301, a set of layout variants are accessed. In some embodiments, the set of variants may be generated automatically by modifying a reasonably good baseline layout based on predefined constraints and/or allowable modification moves, as described with reference to FIG. 1 and FIG. 2A-FIG. 2C. However, the present disclosure is not limited to any particular process or prescribed rules of automatically generating a set of variants.

At 302, the set of layout variants displayed to visitors to the website in accordance with a display probability distribution. The display probability distribution may be an even distribution initially absent factors indicating any preference. User interactions with the webpages associated with these variants are collected, such as clicks, views, and purchases.

At 303, the performances of the set of variants are evaluated and compared based on statistic data collected from visitor interactions with the webpages associated with the variants. As will be appreciated by those skilled in the art, the present disclosure can be applied in any suitable type of webpages used for any purposes. The webpages may contain profit-oriented or non-profit oriented contents and may be hosted by sellers, manufactures, marketers, retailers, licensors, renters, educators, service providers, and etc. The webpages may be devoted to businesses involving e-commerce or traditional commerce and contain information regarding any type of commodities, such as books, clothes, furniture, food, toys, devices, appliances, health products, tickets, services, and human resources, to name a few.

As will be appreciated by those with ordinary skills in the art, the present disclosure is not limited by any particular evaluation metrics or any particular method of evaluation computing. In the context of e-commerce marketing, several marketing performance indicators, or metrics, can be derived from the statistic data and used for evaluating the revenue impact caused by the corresponding layout variant. The evaluation may be based on actual data, estimated data, or predicted data, and so on. In some other embodiments, the performance can be evaluated by computing one or more metrics indicative of direct revenue impact, such as conversion rate, revenue, and profit, which may be either actual or estimated. In some other embodiments, metrics indicative of indirect revenue impact can be used for evaluation computation, such as user clicks and user engagement. In some embodiments, different widgets or different categories of products can be evaluated using different metrics. For a book store for instance, estimated profits generated from advertisements, and other marketing items can be used for non-book related widgets; while conversion rates can be used for book related widgets. In some embodiments, the evaluation results with respect to the set of variants can be ranked in the form of scores.

At 304, the display probability distribution can be adjusted based on the evaluation for subsequent display of the set of variants. In some embodiments, the probability distribution may be adapted to a weighted distribution wherein the distribution values assigned to each variant are maintained substantially proportional to the respective accumulated scores resulted from the process of 303.

In some embodiments, the process of evaluation 303 and dynamic adjustment on the probability distribution 304 can be performed based on a Bayesian variant display strategy. In some of these embodiments, a Beta-Binomial model can be used to maintain the distribution of each variant's v conversion rate rᵥ. For example, assuming p purchases have been observed following an impression, and N impressions in total, the conversion rate of the variant v can be expressed as:

rᵥ˜Beta(αᵥ,βᵥ)=Beta(α+p,β+(N−p)),

where the parameters α and β represent the prior assumptions made on conversion rates, before the data is observed. α may be regarded as pseudo purchases given a variant view, and β may be regarded as the number of non-purchases (e.g., β=N−α where N is the total number of pseudo variant views).

To determine which variant to display at a display instance, in some embodiments, fully Bayesian sampling can be used where data is sampled from each rᵥ, and maxᵥrᵥ can be displayed. Thus, this approach can offer relatively high accuracy. In some embodiments, the rᵥ values may be recomputed after every corresponding impression and purchase, e.g. on-line purchase. The beta-distributed samples of all the variants in the sample may be taken into account to decide what to display for each visiting request. In some other embodiments, pre-sampling can be performed several times, and multinomial distribution can be computed based on the pre-sampling and on the current statistics, followed by sampling from the multinomial. This offline approach may only use one sample to determine what to display thereby reducing the associated computational cost. In some of such embodiments, updates to rᵥ's can occur at predetermined time intervals with a possible slight sacrifice of accuracy.

In some other embodiments, a maximum a posteriori (MAP) estimation of the mean μᵥ of each rᵥ can be used instead of fully sampling. For example,

$${μ}_{v} = \frac{{α}_{v}}{{α}_{v} + {β}_{v}} .$$

μᵥ can be normalized as

$${μ}_{v} := \frac{{μ}_{v}}{{Σ}_{v} {μ}_{v}} .$$

Then sampling can be performed directly from the resulting multinomial μ=[μ₁, . . . , μᵥ]. In this approach, sampling can be fast and simple but less accurate. In some of such embodiments, the updates to the parameters can likely be updated in an online fashion, or via very frequent offline updates. Still in some other embodiments, a combination of above approaches can be used for sampling or selecting a sampling approach.

At 305, based on the performance evaluation results or scores, the set of variants can be dynamically updated by adding new variants or removing variants with inferior performance for subsequent exploration. The updated set of variants are then displayed in accordance with the adjusted probability distribution, and evaluated based on new or accumulated user interactions again.

The foregoing 303-305 are repeated until one or more resultant webpage layouts are determined at 306, e.g. a resultant webpage with the best accumulated conversion rate or with the largest display probability, or any other suitable measure that can be appreciated by those with ordinary skill in the art. In some embodiments, the resultant webpage layout can be used for all the subsequent displays.

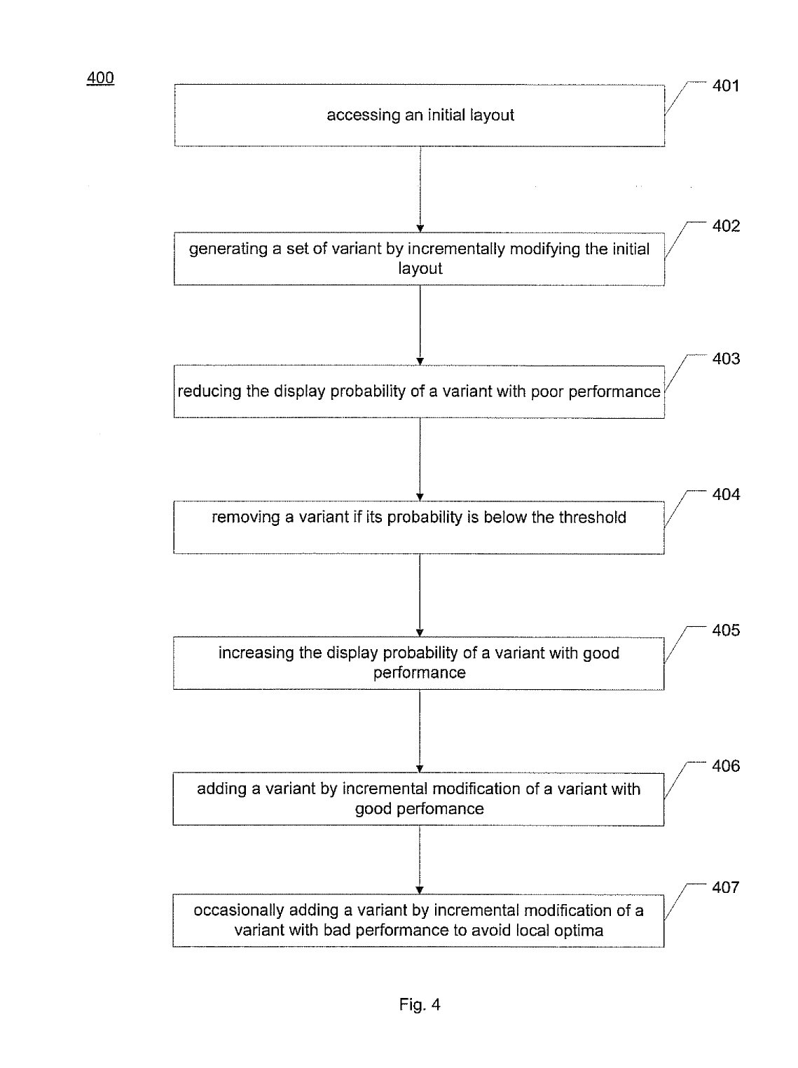

FIG. 4 is a flow chart illustrating an exemplary computer implemented method 400 of dynamically adjusting the compositions of the set of variants during the empirical exploration in accordance with an embodiment of the present disclosure. At 401, a baseline layout is accessed, which may be manually or automatically generated. At 402, a set of variants are automatically and randomly generated based on the predefined constraints and prescribed modification moves, as discussed with reference to FIG. 2A-FIG. 2B. The set of variants may be at first displayed in an equal distribution probability.

As statistic data are collected based on user interaction with the presented variants, evaluations scores are accumulated with respect to each of the set of variants. The display probability of a variant with a poor performance score may be reduced at 403. At 404, if the display probability of a variant falls below a threshold value, it can be discarded. At 405, as for a variant has a superior performance score, e.g., having the highest score, its display probability can be increased, and at the same time the probabilities of the other variants in the set are dialed down correspondingly.

At 406, a new variant can be introduced to the exploration process. In some embodiments, new variants may be subject to the same or similar constraints and criteria as discussed with reference to FIG. 2A-FIG. 2C. As will be appreciated by those with ordinary skill in the art, there are many suitable ways of determining a new variant for exploration that can be used to practice the present disclosure. For example, a new variant can be automatically generated by incrementally modifying the current best variant. A new variant can be selected from a pending previously generated variant. If, for instance, only a fraction of the variants spawned from the baseline variants have been used for exploration, any variant from the remaining part can be added for subsequent exploration. A new variant can also be an additional expert-created variant that are significantly different from the ones already explored.

In some embodiments, the exploration process can follow a greedy method for local search in a discrete search space, which can be useful for converging quickly to local optima but the search space is limited. In some other embodiments, strategies for avoiding local optima can be adopted to discover an optimized variant. For example, hill-climbing steps can be added to the process 400 at 407 wherein every once in a while variants spawned from poorly performing variants are added for exploration. This measure is useful to arrive at different regions of the search space. On the other hand, the measure may results in high regret. Thus, in some embodiments, the exploration scheme can be further improved by incorporating regret for determining how long to explore and display a poorly performing variant.

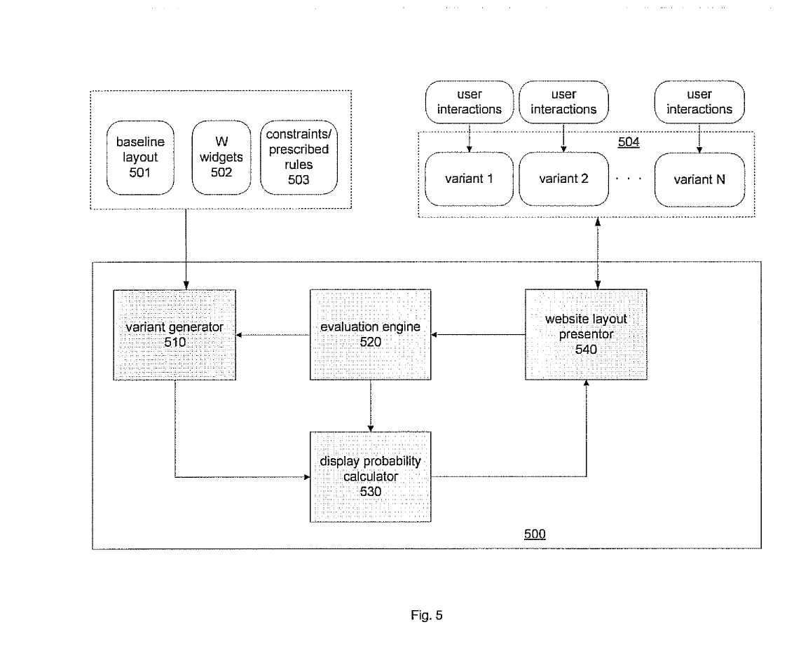

FIG. 5 is a block diagram illustrating an exemplary program and data flow structure of an automatic webpage layout generation system 500 in accordance with an embodiment of the present disclosure. The program 500 comprises several modules including a webpage layout variant generator 510, an evaluation engine 520, a distribution probability calculator 530 and a webpage presenter 540. In some embodiments, these modules can be performed by one server device. While in some other embodiments, they can be performed on different server devices and/or different operation systems. The system 500 is capable of receiving the inputs including the baseline layout 501, a pool of widgets 502 and the predefined constraints and prescribed rules 503, and presenting webpages in different layouts, and eventually presenting webpages in an optimized layout to the visitors to the website.

The variant generator 510 is capable of generating a set of variants based on the inputs 501, 502 and 503. The distribution probability calculator 530 is responsible for determining and assigning display probabilities for the current set of variants. The webpage layout presenter 540, e.g. a server, is capable of populating the layout variants with substantive information and presenting the webpages 504 in different layouts responsive to visiting requests in accordance with the probability distribution. The presenter 540 can also collect data regarding the user interactions with the webpages and send the data to the evaluation engine 520 for analysis and evaluation.

The evaluation results output from the evaluation engine 520 can be used by the variant generator 510 to dynamically adjust the composition of the set of the variants, including discarding or adding a variants, or generating a new variant. The distribution probability calculator 530 is capable of adjusting the display distribution probabilities according to new compositions of the set of variants and results from the evaluation engine 520.

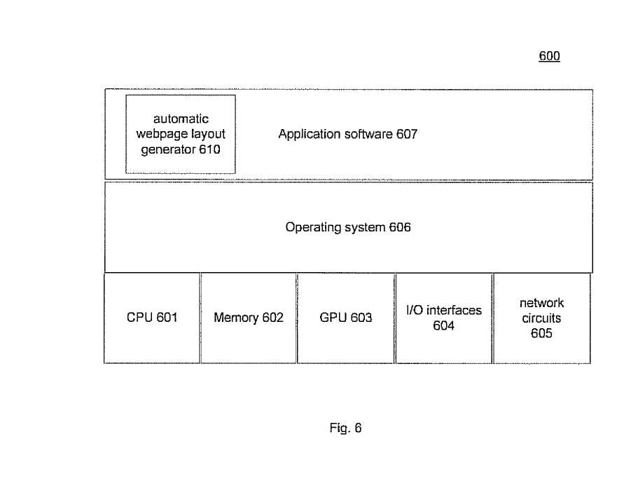

FIG. 6 is a block diagram illustrating an exemplary computing system 600 including an automatic webpage layout generator 610 in accordance with an embodiment of the present disclosure. The computing system comprises a processor 601, a system memory 602, a GPU 603, I/O interfaces 604 and network circuits 605, an operating system 606 and application software 607 including the automatic webpage layout generator 610 stored in the memory 602. When incorporating the user's configuration input and executed by the CPU 601, the automatic webpage layout generator 610 can automatically generate layout variants, present webpages in different layouts and discover an optimized layout empirically in accordance with an embodiment of the present disclosure. The automatic webpage layout generator 610 may perform various functions and processes as discussed in details with reference to FIG. 2A-2C, FIG. 3, FIG. 4 and FIG. 5. As will be appreciated by those with ordinary skills in the art, the automatic webpage layout generator 610 can be implemented in any one or more suitable programming languages that are known to those skilled in the art, such as C, C++, Java, Python, Perl, C#, SQL, etc.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A computer implemented method of automatically determining a webpage layout for a website, said method comprising:
accessing a first webpage layout that comprises a first plurality of widgets arranged in respective page locations;
generating a set of variants based on said first webpage layout in accordance with predefined constraints, wherein each variant is a webpage layout comprising a respective plurality of widgets having respective page locations;
displaying said set of variants to visitors to said website in accordance with a display probability distribution, wherein each variant is assigned with a respective display probability value;
evaluating said set of variants based on statistics collected from respective visitor responses;
adjusting said set of variants and said display probability distribution based on said evaluating;
repeating said evaluating; and
selecting a resultant webpage layout from said set of variants based on said evaluations.

2. The computer implemented method of claim 1, wherein said first webpage layout corresponds to an expert-created webpage layout, and wherein said first plurality of widgets are selected from a group consisting of a search bar, a recommendation list, a marketing image, a list of popular commodities, a list of new commodities, a list of rated commodities, and a combination thereof.

3. The computer implemented method of claim 1, wherein said set of variants are dynamically generated by incrementally modifying said first webpage layout based on said predefined constraints in accordance with a random local process, wherein said incrementally modifying comprises exchanging locations of two widgets of said first plurality of widgets, and substituting a widget of said first plurality of widgets with an additional widget.

4. The computer implemented method of claim 1, wherein said evaluating comprises scoring a performance indicator associated with each of said set of variants, said performance indicator selected from a group consisting of: conversion rate, revenue, profit, clicks, engagement, and a combination thereof.

5. The computer implemented method of claim 4, wherein said adjusting said display probability distribution comprises: dynamically updating said display probability distribution in accordance with a Bayesian strategy based on said scoring said performance indicator.

6. The computer implemented method of claim 6, wherein said Bayesian strategy comprises using a Beta-Binomial model for conversion rate estimation, and using Maximum a posteriori (MAP) approximation with respect to sampling data.

7. The computer implemented method of claim 1, wherein adjusting said set of variants comprises:
adding a new variant to said set of variants; and
removing a variant from said set of variants if a display probability value associated therewith falls below a predetermined threshold, wherein said display probability value is assigned in accordance with corresponding display probability distribution.

8. The computer implemented method of claim 7, wherein said new variant is selected from one of: incremental modification of an existing variant with a superior evaluation score; an incremental modification of said first webpage layout; and an expert-generated variant that is substantially different from said first webpage layout.

9. The computer implemented method of claim 7, wherein said adding a new variant comprises exploring variants spawned from a variant with an inferior evaluation score.

10. A non-transitory computer-readable storage medium embodying instructions that, when executed by a processing device, cause the processing device to perform a method of automatically selecting a webpage layout for a website, said method comprising:
accessing a set of webpage layouts, wherein said set of webpage layouts are generated based on an initial webpage layout in accordance with predefined constraints;
presenting said set of webpage layouts to visitors to said website in accordance with a probability distribution that comprises a respective probability value assigned for each webpage layout of said set of webpage layouts;
evaluating said set of webpage layouts based on visitors' interactions with said set of webpage layouts;
dynamically adjusting said probability distribution based on said evaluating; and
dynamically modifying said set of webpage layouts based on said evaluating and said adjusting;
repeating said evaluating; and
selecting a resultant webpage layout from said set of webpage layouts based on said evaluating.

11. The non-transitory computer-readable storage medium of claim 10, wherein said initial webpage layout comprises an expert-selected webpage layout, wherein said set of webpage layouts are incremental modifications of said initial webpage layout.

12. The non-transitory computer-readable storage medium of claim 10, wherein said modifying comprises:
removing a webpage layout from said set of webpage layouts if a probability value associated thereto falls below a predetermined threshold; and
adding a new webpage layout selected from an incremental modification of said initial webpage layout, an incremental modification of a webpage layout having a superior performance according to said evaluating, and an expert-selected webpage that is substantially different from said initial webpage layout.

13. The non-transitory computer-readable storage medium of claim 11, wherein said evaluating comprises computing a score of a performance indicator for each layout of said set of webpage layouts, wherein said performance indicator is selected from a group consisting of conversion rate, revenue, profit, clicks, and engagement.

14. The non-transitory computer-readable storage medium of claim 13, wherein said dynamically adjusting comprises adjusting said probability distribution based on scores of said performance indicator in accordance with a Bayesian strategy.

15. The non-transitory computer-readable storage medium of claim 13, wherein said Bayesian strategy comprises using a Beta-Binomial model for conversion rate estimation, and using a fully Bayesian sampling method.

16. The non-transitory computer-readable storage medium of claim 10, wherein said modifying further comprising:
adding a webpage layout spawned from a webpage layout having an inferior performance according to said evaluating; and
determining a frequency for said adding by incorporating a Bayesian regret.

17. A system comprising:
a processor;
a network circuit; and
a memory coupled to said processor and comprising instructions that, when executed by said processor, cause the processor to perform an automated method of selecting a webpage layout for a website, said method comprising:
accessing a first webpage layout that comprises a first plurality of widgets arranged in respective page locations;
automatically generating a set of variants based on said first webpage layout in accordance with predefined constraints, each variant corresponding to a webpage layout comprising a respective plurality of widgets arranged in a plurality of page locations;
displaying said set of variants to visitors of said website in accordance with a display probability distribution, each variant assigned with a respective display probability value;
evaluating said set of variants based on statistic data collected from respective visitor responses;
adjusting said set of variants based on said evaluating;
adjusting said display probability distribution based on said evaluating;
repeating said evaluating; and
selecting a resultant webpage layout from said set of variants based on said evaluating.

18. The system of claim 17, wherein said set of variants are generated by incrementally modifying said first webpage layout based on said predefined constraints, and wherein said incrementally modifying comprises exchanging locations of two widgets of said first plurality of widgets, and substituting a widgets of said first plurality of widgets with an additional widget.

19. The system of claim 17, wherein said evaluating comprises scoring a conversion rate associated with each of said set of variants, and wherein said adjusting said display probability distribution comprises: dynamically adjusting said display probability distribution in accordance with a Bayesian strategy based on conversion rate statistics related to said set of variants, and wherein said resultant webpage layouts correspond to a webpage having a high conversion rate.

20. The system of claim 17, wherein adjusting said set of variants comprises:
adding a new variant to said set of variants, wherein said new variant is an incremental modification of a variant having relatively high conversion rate; and
removing a variant from said set of variants if a display probability value associated therewith falls below a predetermined threshold, wherein said display probability value is assigned in accordance with a corresponding display probability distribution.
